(19) United States
(12) Patent Application Publication
(10) Pub. No.: US 2019/0151946 A1
(43) Pub. Date: May 23, 2019

(54) LASER 3D PRINTING METHOD FOR METAL WORKPIECE AND SYSTEM THEREOF

(71) Applicants: Inno Laser Technology Corporation Limited, Shenzhen (CN); Changzhou Inno Machining Co., Ltd., Changzhou (CN)

(72) Inventors: Xiaojie Zhao, Ronkonkoma, NY (US); Sha Tao, Shenzhen (CN); Guoshuang Qin, Shenzhen (CN)

(21) Appl. No.: 16/244,085

(22) Filed: Jan. 9, 2019

Related U.S. Application Data
(63) Continuation of application No. PCT/CN2017/106247, filed on Oct. 16, 2017.

(30) Foreign Application Priority Data
Jun. 30, 2017 (CN) 201710519153.0

(51) Int. Cl. B22F 3/105; B33Y 10/00; B33Y 30/00; B33Y 40/00; B33Y 50/02; B22F 3/24

(52) U.S. Cl. CPC B22F 3/1055; B33Y 10/00; B33Y 30/00; B33Y 40/00; B22F 2003/247; B22F 3/24; B22F 2003/1059; B22F 2003/1057; B33Y 50/02

(57) ABSTRACT

A laser 3D printing method for metal workpiece and system thereof, and the method comprises the following steps: step one, performing 3D sintering to metal powder by using a continuous laser or a pulse laser; step two, performing laser-induced shock wave impact to a 3D sintered component by using a short pulse width laser; step three, polishing the 3D sintered component obtained after the step two by using a continuous laser or a pulse laser. When the workpiece to be printed comprises powders of various materials, select a laser wavelength, pulse energy and pulse width according to an optical characteristic of the powder of each material, use the three steps to realize a printing of functionally graded materials. Compared with the prior art, the laser 3D printing system for metal workpiece could improve the occurrence of holes, over-burning and spheroidization phenomenon, thereby increasing the density of the metal workpiece.

### CROSS REFERENCE TO RELATED APPLICATION

The present application is a Continuation Application of PCT Application No. PCT/CN2017/106247, field on Oct. 16, 2017, which claims the benefit of Chinese Patent Application No. 201710519153.0 filed on Jun. 30, 2017. All the above are hereby incorporated by reference.

### FIELD OF THE INVENTION

The present application relates to the technical field of 3D printing, and more particularly, to a laser 3D printing method for metal workpiece and system thereof.

### BACKGROUND OF THE INVENTION

3D printing technology is a technology of constructing object by using adhesive material such powder metal or plastic and layer-by-layer printing based on digital model files. It could produce parts of any shape directly from computer graphics data without needing machining or any mold, which greatly reduces a product development cycle and improves productivity and reduces production cost.

Laser sintering technology adopts the principle that powder material is sintered under laser irradiation and is formed layer-by-layer under control of a computer. Laser sintering technology could use a lot of powder materials to produce finished product of corresponding material. The finished product produced by laser sintering has good precision and high intensity, and the main advantage of laser sintering is the application of metal product manufacturing. Laser sintering could directly or indirectly sinter metal parts, and the final product is far stronger than that of other 3D printing technologies.

However, the traditional 3D printing for metal workpiece has great defect in the connecting or disconnecting performance, mainly because the laser 3D printing is a technology of stacking layer-by-layer, and the holes, over-burning and spheroidization phenomenon appear in the printing process, so the metal workpiece formed by printing has a low density.

### SUMMARY OF THE INVENTION

The embodiments of the present application provide a laser 3D printing method for metal workpiece and a system thereof, which could solve the technical problem of low density of 3D printed metal workpiece of prior art.

A technical solution provided by the embodiments of the present application is:

A laser 3D printing method for metal workpiece, comprises the following steps:

Step one, performing 3D sintering to metal powder by using a continuous laser or a pulse laser;

Step two, performing laser-induced shock wave impact to a 3D sintered component by using a short pulse width laser; wherein the short pulse width refers to a pulse width of less than 100 ns;

Step three, polishing the 3D sintered component obtained after the step two by using a continuous laser or a pulse laser.

Wherein, when the 3D printing involves powders of various materials, the method further comprises: selecting a laser wavelength, pulse energy and pulse width according to an optical characteristic of the powder of each material, repeating the process from the step one to step three, to realize a printing of functionally graded materials.

A system for implementing the laser 3D printing method for metal workpiece described above, comprising: an industrial personal computer; a laser scanning device connected to and controlled by the industrial personal computer; and a metal pool device connected to and controlled by the industrial personal computer and receiving a scan of the laser scanning device for 3D printing of the metal workpiece.

Wherein, the metal pool device comprises a seal chamber and a powder cylinder, a molding cylinder and a powder coating roller which are provided in the seal chamber.

Wherein, the metal pool device further comprises an air extracting device communicating with the seal chamber.

Wherein, a dust purifier is disposed on a communication passage connecting the air extracting device and the seal chamber.

Wherein, the metal pool device further comprises a gas-filling device communicating with the seal chamber.

Wherein, the laser scanning device comprises: a laser connected to an industrial personal computer and for adjusting a pulse width of a laser beam emitted according to the control of the industrial personal computer, a beam expanding device connected to the laser, a vibrating mirror and lens assembly connected to the beam expanding device and for performing a laser scanning to the metal pool device.

Compared with the prior art, the laser 3D printing method for metal workpiece of the embodiments of the present application controls the degree of laser sintering by changing the width of the laser pulse, so the occurrence of holes, over-burning and spheroidization phenomenon in the printing process of metal workpiece is improved, thereby increasing the density of the metal workpiece.

### BRIEF DESCRIPTION OF THE DRAWINGS

FIG. 1 is a functional block diagram of a laser 3D printing system for metal workpiece of the present application.

FIG. 2 is a flow chart of a 3D printing method using a laser 3D printing system for metal workpiece of the present application.

### DESCRIPTION OF THE EMBODIMENTS

The present application will be further described in detail below with reference to the accompanying drawings.

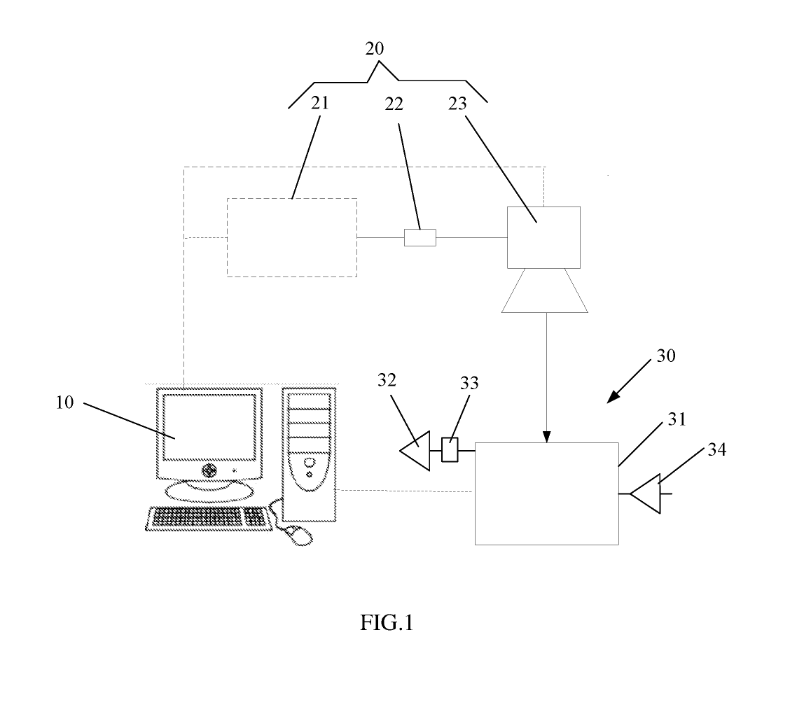

Referring to FIG. 1, in the embodiment, referring to FIG. 1, a laser 3D printing system for metal workpiece of the present embodiment mainly comprises an industrial personal computer 10, a laser scanning device 20 and a metal pool device 30. The industrial personal computer 10 controls the laser scanning device 20 to perform 3D printing to the metal powder placed in the metal pool device 30.

Wherein, the industrial personal computer 10 is connected to the laser scanning device 20 and the metal pool device 30, and controls the laser scanning device 20 and the metal pool device 30.

Further, the laser scanning device 20 comprises: a laser 21 connected to an industrial personal computer 10 and for adjusting a pulse width of a laser beam emitted according to the control of the industrial personal computer 10, a beam expanding device 22 connected to the laser 21, a vibrating mirror and lens assembly 23 connected to the beam expanding device 22 and for performing a laser scanning to the metal pool device 30.

Wherein, the metal pool device 30 comprises a seal chamber 31, an air extracting device 32 communicating with the seal chamber 31, a dust purifier 33 disposed on a communication passage connecting the air extracting device 32 and the seal chamber 31, and a gas-filling device 34 communicating with the seal chamber 31.

Wherein, the metal pool device 30 further comprises a powder cylinder, a molding cylinder and a powder coating roller (not shown in the figure) which are provided in the seal chamber 31.

Preferably, a plurality of sensors could be disposed in the seal chamber 31, for monitoring a working environment and working state in the seal chamber 31.

More specifically, the air extracting device 32 may be a vacuum pump; the protective gas delivered by the gas-filling device 34 may be one or more selected from: argon gas, helium gas and other inert gases, and the protective gas isolates the metal powder from the air, thereby preventing the metal powder from being oxidized.

The working principle of the 3D printing system for metal workpiece of the present embodiment is as follows: in the laser 3D printing process, the industrial personal computer 10 controls the operation of the air extracting device 32 to evacuate the air from the seal chamber 31, and then the industrial personal computer 10 controls to turn off the air extracting device 32, and to turn on the dust purifier 33 and the gas-filling device 34 to deliver the protective gas to fill the seal chamber 31; the powder coating roller lays a first layer of metal powder to a predetermined position, and the industrial personal computer 10 adjusts the laser 21 to emit a laser beam with a predetermined pulse, and controls the laser beam to scan according to a filling scanning path of the first layer, thereby sintering the first layer of metal powder laid; after processing the first layer, the powder cylinder rises by a distance of a certain thickness, the powder coating roller lays a second layer of metal powder on the processed first layer, and the industrial computer 10 adjusts the laser 21 to emit a laser beam with a predetermined pulse, and controls the laser beam to scan according to a filling scanning path of the second layer, thereby sintering the second layer of metal powder laid; process layer by layer like this until the printing of the entire metal workpiece is completed.

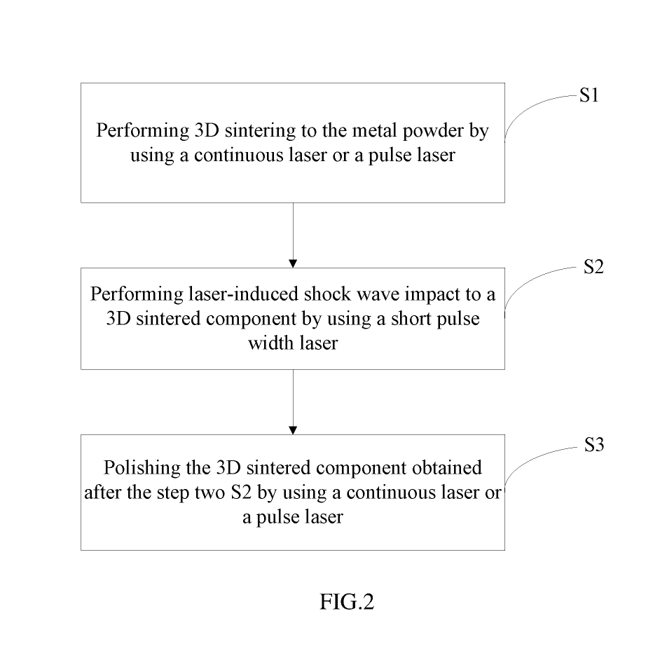

Referring to FIG. 2, the embodiment of the present application further discloses a 3D printing method using the laser 3D printing system for metal workpiece described above, and the method comprises the following steps:

Step one S1, performing 3D sintering to the metal powder by using a continuous laser or a pulse laser;

Step two S2, performing laser-induced shock wave impact (laser shock peening) to a 3D sintered component by using a short pulse width (<100 ns) laser at the same time as or after sintering to enhance the mechanical properties of the component;

Step three S3, polishing the 3D sintered component obtained after the step two S2 by using a continuous laser or a pulse laser according to actual needs;

Step four (not shown in the figure), when the 3D printing involves powders of various materials, such as using different materials (powders) in adjacent layers, or using different materials (powders) in different positions of a same layer, select a suitable laser wavelength, pulse energy and pulse width according to one or more optical characteristics of each material (powder) to be used in the above method, to realize a printing, impact and polishing of functionally graded materials.

The 3D printing system for metal workpiece of the present embodiment adjusts the pulse width of the laser beam to change the energy absorbed by the metal powder, thereby changing the melting quality of the metal particles of the metal powder, thereby reducing the viscosity and surface tension of the metal melt, and increasing the depth and width of the molten pool, so as to increase adhesion between the metal particles, thereby increasing the density of the metal workpiece.

The above description is only the preferred embodiments of the present application, and is not intended to limit the embodiments of the present application. Persons skilled in the art could easily make corresponding alternatives and modifications according to the main idea and spirit of the present application. The protection scope of the present application should be subject to the protection scope claimed in the claims.

What is claimed is:

1. A laser 3D printing method for metal workpiece, comprising the following steps:
step one, performing 3D sintering to metal powder by using a continuous laser or a pulse laser;
step two, performing laser-induced shock wave impact to a 3D sintered component by using a short pulse width laser; wherein the short pulse width refers to a pulse width of less than 100 ns;
step three, polishing the 3D sintered component obtained after the step two by using a continuous laser or a pulse laser.

2. The laser 3D printing method for metal workpiece according to claim 1, wherein when the 3D printing involves powders of various materials, the method further comprises: selecting a laser wavelength, pulse energy and pulse width according to an optical characteristic of the powder of each material, repeating the process from the step one to step three, to realize a printing of functionally graded materials.

3. A system for implementing the laser 3D printing method for metal workpiece according to claim 1, comprising: an industrial personal computer; a laser scanning device connected to and controlled by the industrial personal computer; and a metal pool device connected to and controlled by the industrial personal computer and receiving a scan of the laser scanning device for 3D printing of the metal workpiece.

4. The system according to claim 3, wherein the metal pool device comprises a seal chamber and a powder cylinder, a molding cylinder and a powder coating roller which are provided in the seal chamber.

5. The system according to claim 4, wherein the metal pool device further comprises an air extracting device communicating with the seal chamber.

6. The system according to claim 5, wherein a dust purifier is disposed on a communication passage connecting the air extracting device and the seal chamber.

7. The system according to claim 4, wherein the metal pool device further comprises a gas-filling device communicating with the seal chamber.

8. The system according to claim 3, wherein the laser scanning device comprises: a laser connected to an industrial personal computer and for adjusting a pulse width of a laser beam emitted according to the control of the industrial personal computer, a beam expanding device connected to the laser, a vibrating mirror and lens assembly connected to the beam expanding device and for performing a laser scanning to the metal pool device.
